(19) United States
(12) Patent Application Publication
(10) Pub. No.: US 2005/0210685 A1
(43) Pub. Date: Sep. 29, 2005

(54) Brake mechanism for tool

(76) Inventor: Jung-Chang Jong, Chungli City (TW)

Correspondence Address: SUPREME PATENT SERVICES, POST OFFICE BOX 2339, SARATOGA, CA, 95070, US

(21) Appl. No.: 10/809,778

(22) Filed: Mar. 24, 2004

(51) Int. Cl. B60T 13/04

(52) U.S. Cl. 30/382; 188/166

(57) ABSTRACT

A brake mechanism includes a trigger device and a brake device arranged in a casing of a tool. The trigger device is a switch to activate the power. The brake device is to depress the power that is transmitted to the output shaft. The output shaft is wrapped by a flexible band which has one end fixed to the casing and the other end is connected to a connection device which is activated by the trigger device or the brake device so as to be pull the flexible band to change the friction to the output shaft.

### FIELD OF THE INVENTION

The present invention relates to a brake mechanism that controls a flexible brake band to compress and induce braking force against the rotation of a shaft.

### BACKGROUND OF THE INVENTION

A conventional brake mechanism for a power tool having an output shaft, such as an electric saw, includes a brake board and a clutch device that is controlled by the brake board. By controlling the clutch device, the output shaft can be engaged with or released from the power transmitting mechanism. When braking, the output shaft is released from the power transmitting mechanism so that no power is provided to the output shaft. However, the output shaft has an inertial force and keeps on rotating after the brake mechanism is activated. The rotation of the output may hurt people and/or properties even if the power transmitting mechanism is disengaged from the output shaft. Besides, the clutch device involves a complicated structure and assembling is quite time consuming.

Therefore, it is desired to have a brake mechanism that resolves one or more drawbacks of the conventional brake mechanisms.

### SUMMARY OF THE INVENTION

In accordance with an aspect of the present invention, there is provided a brake mechanism of a tool. The brake mechanism comprises a trigger device and a brake device. The brake device includes a brake board, a first connection device and a flexible band. The brake board has a connection rod extending through the casing and connected to the first connection device. The flexible band wraps the output shaft and has one end fixed to the casing and the other end connected to the first connection device such that the flexible band is pulled to change friction with the output shaft by operating the brake board.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 is an exploded view of a brake mechanism in accordance with the present invention to be mounted to a casing of a tool;

FIG. 2 is a perspective view showing the brake mechanism mounted to the tool casing;

FIG. 3 is a side view showing the brake mechanism connected to the tool casing;

FIG. 4 shows a flexible band in a condition of being not yet pulled by a brake board, and

FIG. 5 shows the flexible band in a condition of being not yet pulled by a trigger device.

### DETAILED DESCRIPTION OF THE PREFERRED EMBODIMENT

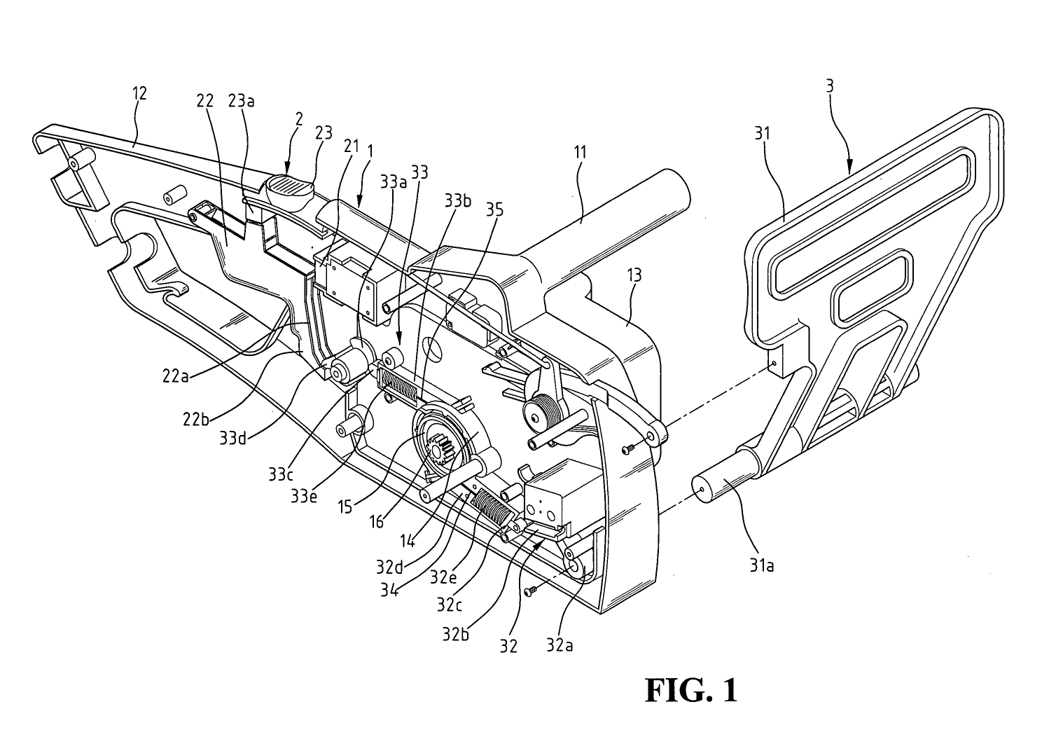

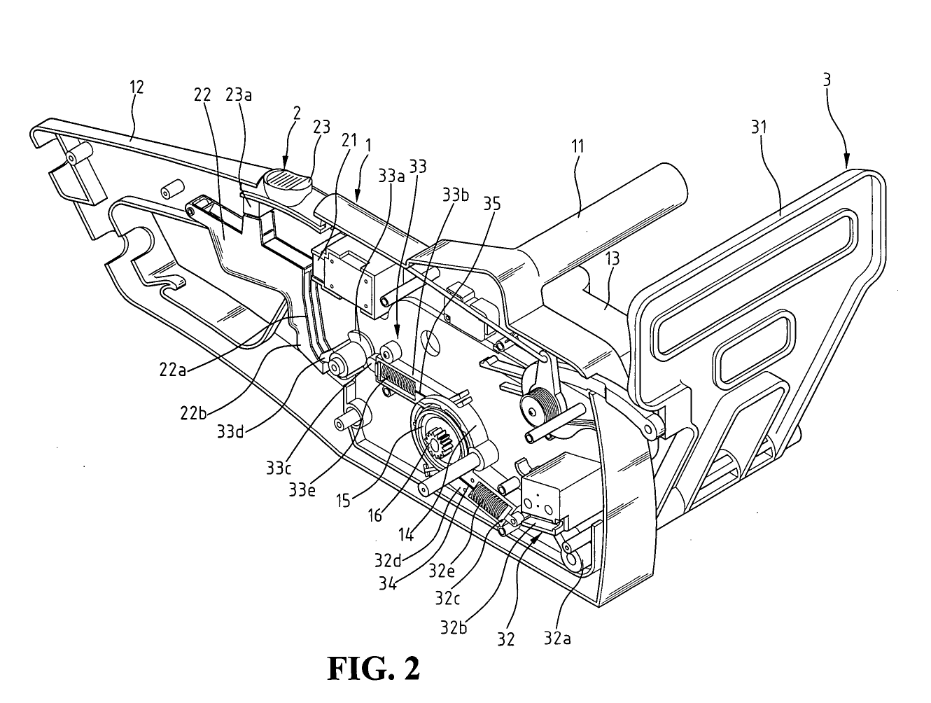

Referring to the drawings and in particular FIGS. 1-3, a brake mechanism in accordance with the present invention is incorporated in a power tool, such as an electric tool, for example an electric saw, which comprises a casing 1 and a power mechanism 13 providing power to the tool. The power mechanism 13 drives an output shaft 15 that is located in a chamber 14 inside the casing 1. The output shaft 15 drives an output port 16. The brake mechanism comprises a trigger device 2 and a brake device 3. The trigger device 2 includes an auto-reserve switch 21, a trigger 22 and a safety button 23. The auto-reserve switch 21 is located close to the handle 12 of the tool. The trigger 22 has one end pivotably connected to the handle 12 so that it can only be pivoted a limited angle. The other end of the trigger 22 includes a curve surface 22a. A driving end 22b extends from a lower edge of the curve surface 22a so that when the trigger 22 is rotated, the curve surface 22a activates the auto-reverse switch 21. A safety button 23 is slidably connected to a top of the casing 1 and has a protrusion 23a on an underside thereof. The protrusion 23a contacts a top of the trigger 22 so as to prevent the trigger 22 from moving upward.

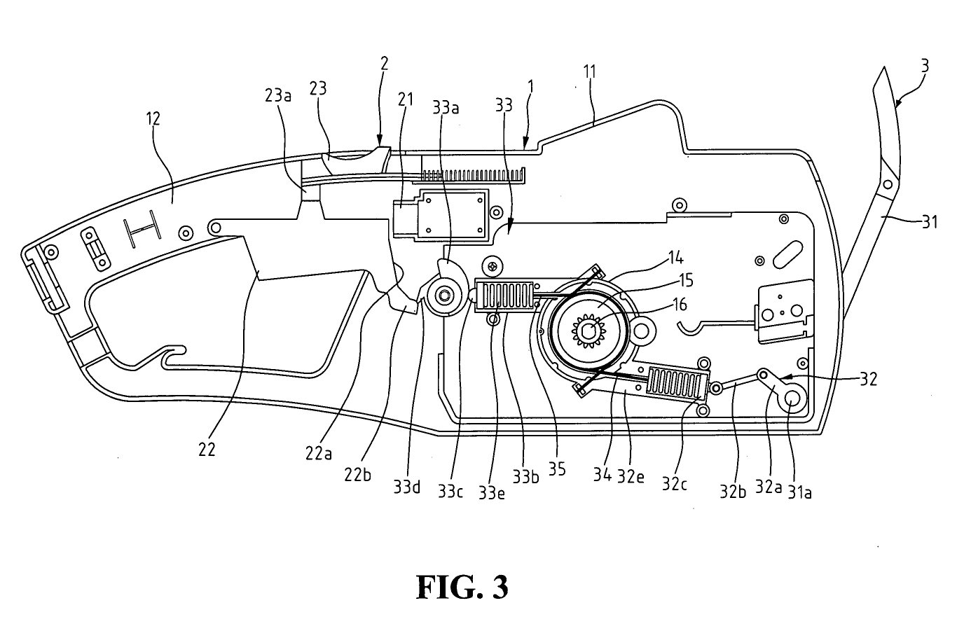

The brake device 3 includes a brake board 31, a first connection device 32, a second connection device 33, a first flexible band 34, and a second flexible band 35. The brake board 31 has a connection rod 31a that extends through the casing 1 and is connected to an end of the first connection device 32. The first connection device 32 is a link mechanism and includes a first link 32a connected to the connection rod 31a of the brake board 31 and pivotably connected to a second link 32b. A sliding member 32c is connected to the second link 32b and movably retained in a groove 32d. A spring 32e is received in the groove 32d and biasing the sliding member 32c at an initial position. The first flexible band 34 wraps around the output shaft 15 and has one end fixed to the casing 1 and the other end connected to the sliding member 32c of the first connection device 32. Therefore, as shown in FIG. 3, when the brake board 31 is pulled, the first flexible band 34 is driven to contact the output shaft 15, which is then stopped by the friction between the first flexible band 34 and the output shaft 15. The spring 32e provides a return force for the brake board 31 when the user releases the brake board 31.

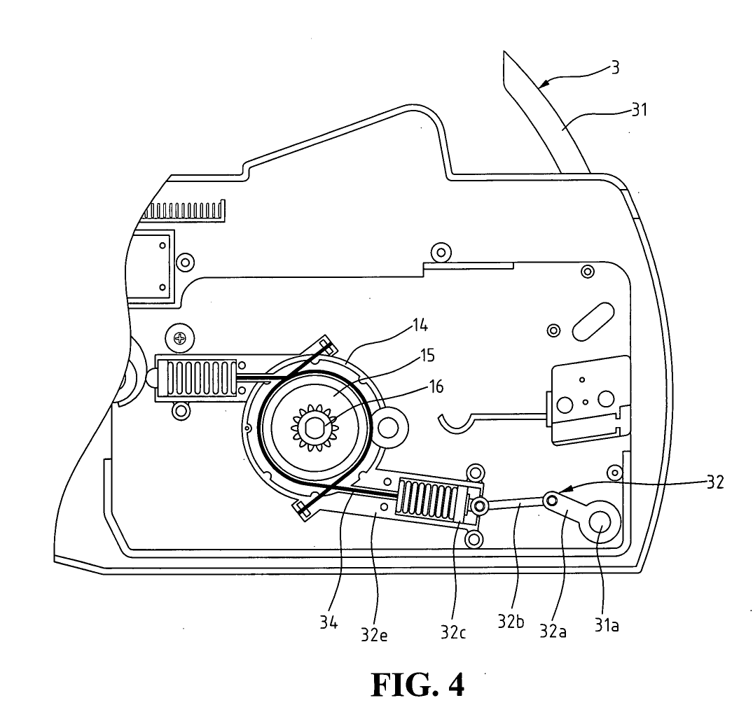

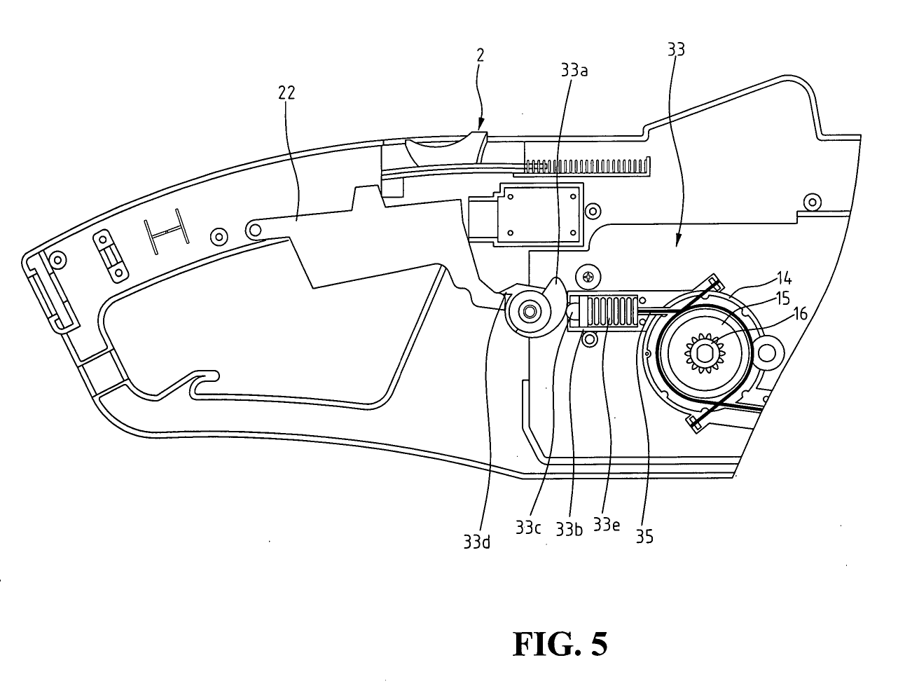

Further referring to FIG. 5, the second connection device 33 includes a cam that has a protrusion board 33a having a specific contour and a tongue 33d that is driven by the driving end 22b of the trigger 22 when the user grasps the trigger 22 to rotate the cam. A block 33c is slidably retained in a second groove 33b and a spring 33e is received in the second groove 33b so as to bias the block 33c to an initial position. The second flexible band 35 wraps around the output shaft 15 and has one end fixed to the casing 1 and the other end connected to the block 33c of the second connection device 33. When the tool is used, the safety button 23 is shifted and the user grasps the trigger 22; the driving end 22b rotates the cam so that the block 33c is pushed by the protrusion board 33a and the second flexible band 35 does not contact the output shaft 15 which may output a torque as designed. If the safety button 23 is shifted to the position as shown in FIGS. 3 and 4, the block 33c is pushed by the spring 33e to cause the second flexible band 35 to contact the output shaft 15 which is not able to rotate.

It is noted that the sliding member 32c or the block 33c can be omitted if the first spring 32e or the second spring 33e can operate the first connection device 32 or the second connection device 33. Furthermore, if the first spring 32e or the second spring 33e is able to complete the brake function, one spring 32e or 33e can be omitted.

While we have shown and described the embodiment in accordance with the present invention, it should be clear to those skilled in the art that further embodiments may be made without departing from the scope of the present invention.

1. A brake mechanism of a tool having a casing and an output shaft, comprising:
a trigger device comprising a switch for selectively activating power of the tool; and
a brake device adapted to depress a transmission of power of the tool, the brake device comprising a brake board, a first connection device and a flexible band, the brake board having a connection rod extending through the casing and connected to the first connection device, the first connection device being a link mechanism which is activated by the connection rod of the brake device, the flexible band wrapping around the output shaft and having one end fixed to the casing and the other end connected to the first connection device, the flexible band being pulled to change friction with the output shaft.

2. The brake device as claimed in claim 1, wherein the first connection device comprises a first link connected to the connection rod of the brake board and pivotably connected to a second link, a sliding member connected to the second link and movably retained in a groove, a spring received in the groove and biasing the sliding member at an initial position.

3. The brake device as claimed in claim 1, wherein the trigger device comprises a trigger that has an end pivotably connected to the casing and the other end engaged with a second connection device, the brake device having a second flexible band which wraps around the output shaft and has one end fixed to the casing and the other end connected to the second connection device.

4. The brake device as claimed in claim 3, wherein the second connection device comprises a cam which has a protrusion board and a tongue which is driven by a driving end of the trigger so as to rotate the cam, a block slidably retained in a second groove and connected to said the other end of the second flexible band, the block being pushed by the protrusion board and a spring received in the second groove so as to bias the block at an initial position.

5. A brake mechanism of a tool having a casing and an output shaft, comprising:
a trigger device comprising a switch for selectively activating power of the tool; and
a brake device adapted to depress a transmission of power of the tool, the brake device comprising a connection device and a flexible band, the connection device being a link mechanism which is activated by the trigger device, the flexible band wrapping the output shaft and having one end fixed to the casing and the other end engaged with the connection device, the flexible band being pulled by the connection device to change friction with the output shaft.

6. The brake device as claimed in claim 5, wherein the connection device comprises a cam which has a protrusion board and a tongue which is driven by a driving end of the trigger so rotate the cam, a block slidably retained in a groove and connected to said the other end of the flexible band, the block being pushed by the protrusion board and a spring received in the groove so as to bias the block to an initial position.
